(19) United States
(12) Patent Application Publication
(10) Pub. No.: US 2012/0314011 A1
(43) Pub. Date: Dec. 13, 2012

(54) METHOD AND APPLYING A CURABLE HOT-MELT INK ON A MEDIUM

(75) Inventors: Peter M. A. WETJENS, Sevenum (NL); Gerardus C.P. VERCOULEN, Velden (NL); Joost A. VEERMAN, Grubbenvorst (NL); Hendrik J.A. OGRINC, Velden (NL); Robertus C.W.T.M. VAN DEN TILLAART, Gemert (NL); Maosheng REN, Eindhoven (NL); Tomislav PILJIC, Geldrop (NL)

(73) Assignee: OCE TECHNOLOGIES B.V., Venlo (NL)

(21) Appl. No.: 13/465,692

(22) Filed: May 7, 2012

Related U.S. Application Data
(63) Continuation of application No. PCT/EP2010/067440, filed on Nov. 15, 2010.

(30) Foreign Application Priority Data
Nov. 18, 2009 (EP) 09176326.8

(51) Int. Cl. B41J 2/01

(52) U.S. Cl. 347/102

(57) ABSTRACT

In a method for applying a curable hot-melt ink the ink is applied in a fluid state on a medium, in particular a recording medium or an intermediate transfer member, on which the ink cools, thereby thickening. Then, the applied ink is at least partly heated such that the viscosity of at least a part of the ink decreases. Thereafter, the ink is cured. The method is suitable for providing a high gloss image and/or for improving an ink transfer from the intermediate transfer member to a recording medium and/or for improving an adhesion of the ink on the recording medium.

### FIELD OF THE INVENTION

The present invention relates to a method for applying an curable hot-melt ink on a medium. The present invention also relates to a corresponding apparatus for applying a curable hot-melt ink on a medium.

### BACKGROUND OF THE INVENTION

In a known printing process using a radiation curable hot-melt ink, the curable ink comprises a gelling agent. Prior to application of droplets of ink on a medium, the ink is heated in order to breakdown the gelling structure such that a fluid ink, suitable for ejection by an inkjet print head, is obtained. At least partly thickening of ink droplets on a surface of the medium is induced by allowing the ink to cool down. The thickening of the ink droplets provides control over the droplet spreading on the surface of the medium. As a result interaction between adjacent droplets is controllable. In fact, thickening of droplets may be used to restrict bleed of ink droplets (i.e. ink mixing between adjacent amounts of ink having a different color), which droplets are applied image wise on the medium. In a next step curing of these ink droplets is carried out by irradiating the ink droplets with UV light in order to provide a mechanically robust image. With a mechanically robust image a scratch and/or smear resistant image is meant. In general, applied images constituted by an UV curable hot-melt ink may have a matte gloss appearance. While known curable hot-melt ink printing processes are suitable for providing matte gloss images, a need remains for images having a high gloss level. For example for printing photo's or other applications of colored images may benefit from higher gloss.

### SUMMARY OF THE INVENTION

It is an object of the present invention to provide a method of applying UV curable hot-melt ink and a corresponding apparatus, by which method an image may be provided having a high gloss level.

In the method according to the present invention, application of a curable hot-melt ink on a medium comprises the steps of: a) providing an amount of curable hot-melt ink in a fluid state; b) applying at least a part of the ink on a surface of the medium and allowing the ink to cool upon the application on the surface; c) heating at least a part of the ink applied in step b); and d) curing the ink; wherein step c) is started before step d) is started.

A curable hot-melt ink suitable for use in the method according to the present invention comprises a carrier composition that comprises one or more radiation curable compounds and at least one hot-melt agent. The hot-melt agent may be a melt able component, such as a organic crystalline component. The melt able component is such that the carrier composition is enabled to reversibly liquefy upon heating. The hot-melt agent may be a thickener, for example.

In one embodiment, the thickener induces solidification of the carrier upon cooling of the ink to a temperature below an application temperature. In another embodiment, a thickener may be provided that is able to reversibly gel the carrier composition and provides a gelled carrier composition at a temperature below the application temperature. In any case, the curable hot-melt ink is configured to reversibly liquefy and thicken upon heating and cooling, respectively.

In the method according to the present invention, the curable hot-melt ink is provided in a fluid state. The fluid state may be obtained by heating (solidifying or gelling ink), but may also be obtained by application of shear, or the like, on a (thixotropic) gelling ink, for example. In the fluid state, the viscosity of the ink is decreased with respect to ink in a thickened state. The fluid ink is then provided to a print head for application on a surface of a medium. Prior to application, the ink is heated to an elevated temperature such that the ink may thicken (solidifying or gelling) upon cooling. As used hereinafter, thickening is to be understood to an increase of a viscosity, possibly ultimately resulting in solidification.

At least a part of the ink is applied on a surface of the medium. The applying step may be done by using any known application technique that allows the ink to be applied image wise to the surface of a medium. For example the applying step may be done by using a printing technique such as inkjet printing, screen printing, offset printing and the like. In any way, during the application step of a part of the ink on the surface of the medium, the temperature of the ink is higher than the temperature of the surface of the medium. As a result, the ink on the surface of the medium will cool upon application. Upon cooling of the ink on the surface of the medium, the ink thickens according to its ink properties. The thickening of the ink according to the present invention is such that the ink spreading on the surface of the medium is controlled.

It is observed that the thickening of the ink may also effect the light reflection of the applied ink such that a disturbance of light reflection may occur, leading to a low gloss of the applied ink before the applied ink is cured. It may be assumed that the disturbance of light reflection may be caused by phase separation of the hot-melt components from other ink components and/or the disturbance of light reflection may be caused by a disturbance of the smoothness of the surface of the ink. In any case, in the prior art, a resulting image has a low gloss appearance, as above mentioned. With the method according to the present invention the ink is at least partly heated after application of the ink on the surface of the medium. Such heating of the ink after application of the ink on the surface of the medium may increase the gloss level of the ink. It is assumed that an increase in gloss of the ink may be caused by leveling of the surface of the ink such that a smoother surface is provided and /or an increase in gloss of the ink may be caused by reducing the phase separation of the hot-melt components in the other ink components.

The heating of the ink may be carried out by any suitable heating means configured for (partly) heating the ink. In an embodiment heating of the ink may be carried out by providing infrared radiation to the ink.

By only partly heating the ink, the ink may be heated without disturbing the control on the spreading of the ink on the surface. It is assumed that upon partly heating, another part of the ink remains sufficiently thick and thus the control on the spreading of the ink on the surface may be maintained. In such a way the ink is restrained from excessive spreading on the surface of the medium and/or is restrained from ink bleed.

Further in accordance with the method of the present invention, the ink is cured. The curing step may be performed by any suitable curing method. The method depends, of course, on the curing properties of the ink. For example, the curing of the ink may be provided by electron beam treatment or UV-radiation treatment of the ink. By curing the ink a hardened ink is obtained. The hardened ink provides a mechanical durability to the image. Moreover, after the curing step the image maintains its gloss. So, if a relatively high gloss level is desired, the gloss level of the uncured ink may be increased and maintained until curing. In accordance with the present invention, an increased gloss is provided by the heating of the at least partly thickened ink applied on the medium. As indicated, the gloss should be increased prior to curing. Therefore, in accordance with the present invention, the heating step begins before the curing step begins. The heating step may be ended before the curing step begins. The inventors have also found that the heating step may be continued during the curing step.

In one embodiment of the present invention, the method is applied not so much as to control a gloss level, but to control application of the ink on a recording medium. In this embodiment, the heated ink is applied on an intermediate transfer member and is later transferred from the intermediate transfer member to a recording medium, such as paper, for example. Upon application of the ink having an elevated temperature on the intermediate, the ink thickens. The thickened ink may have a relatively poor transfer from the intermediate to the recording medium and/or may have a relatively poor bonding on the recording medium. In order to improve the transfer and/or the bonding, the ink applied on the intermediate may be heated to become (at least partly) fluid again shortly before transfer. Please note, that a gloss level may as well be controlled in this embodiment. Moreover, in a further embodiment, the ink may be heated again after transfer to the recording medium in order to control the gloss.

In an aspect of the present invention, a printing device for applying a curable hot-melt ink on a medium is provided and comprises a) an ink supply means configured for providing at least an amount of the ink in a fluid state; b) an ink application means in fluid coupling with the ink supply means for receiving the fluid ink, the ink application means being configured for applying the fluid ink to a surface of the medium at an elevated temperature; c) a heating means configured for heating at least a part of the ink applied on the surface of the medium; and d) a curing means configured for curing the ink. Hence, a printing device configured for performing the method according to the present invention is provided.

In one embodiment, the heating means comprises a infrared radiation generating means for irradiation of the ink with infrared radiation. Further, in one embodiment, the curing means comprises an ultraviolet (UV) radiation generating means for irradiating the ink with UV radiation for curing the ink. In a particular embodiment, a single radiation source is provided for providing both the infrared radiation and the ultraviolet radiation. In such an embodiment, a filter element is provided for filtering the UV radiation from the radiation, such that the ink is first irradiated with infrared radiation only for heating and thereafter is irradiated with UV radiation for curing. It is noted that during the curing with UV radiation, the infrared radiation may be provided as well or the infrared radiation may be filtered by a second filter element.

In accordance with above described embodiments of the method according to the present invention, the medium may be a recording medium or may be an intermediate transfer member.

In a particular embodiment of the printing device according to the present invention, the printing device comprises a control unit operatively coupled to the heating means. In this embodiment, the gloss level may be a user-settable parameter such that a user may indicate a desired gloss level. The control unit may control the heating means in response to the user settable parameter for controlling the heating of the ink such that the resulting gloss level is controlled corresponding to the user-settable parameter.

In a method according to the present invention in step b), the ink cools down after being applied on a surface of the medium, whereby the ink is provided in an at least partially thickened state. When the ink is in an at least partially thickened state after being applied on a surface of the medium, at least a part of the ink applied on the surface of the medium is heated, thereby providing a fraction of the ink that has returned to the fluid state. The fraction of the ink that has returned to the fluid state has a decreased viscosity, compared to the at least partially thickened state the ink is in after cooling down on the surface of the medium after being applied on said surface. After starting heating of at least a part of the ink, curing of the fraction of the ink that has returned to the fluid state takes place is started, thereby curing at least the fraction of the ink that has returned to the fluid state is cured. Optionally, other fractions of the ink may be cured as well.

Thus, after applying the ink on the surface of the medium, the ink at least partially thickens (solidifies or gels). When the ink has (at least partially) thickened, the ink is heated, such that at least a part of the ink returns to the fluid state (melts or returns from gelled state). Then the image is cured. Thus, by starting heating the ink that has thickened, such that the ink at least partially melts, before curing is started, the ink that is cured in step d) is at least partially in a fluid state, thereby improving the gloss of the image printed.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

Hereinafter, the present invention is elucidated with reference to the appended drawings showing non-limiting embodiments and wherein:

FIG. 1 shows a schematic perspective view of an inkjet printing device;

FIG. 2 schematically illustrates a first embodiment of the method in accordance with the present invention;

FIG. 3A schematically illustrates a second embodiment of a method according to the present invention;

FIG. 3B illustrates a particular configuration of the embodiment according to FIG. 3A;

FIG. 4 schematically illustrates a third embodiment of a method according to the present invention;

FIG. 5 schematically illustrates a fourth embodiment of a method according to the present invention.

### DETAILED DESCRIPTION

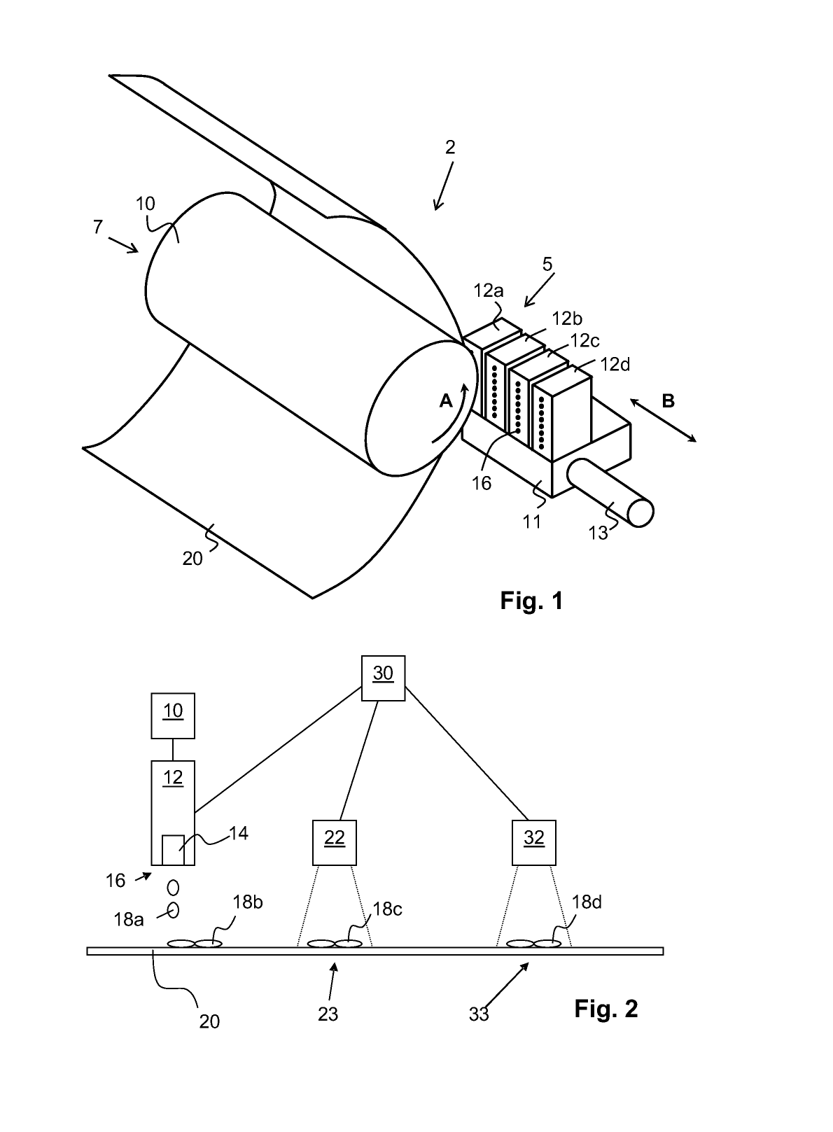

In the drawings, same reference numerals refer to same elements. FIG. 1 illustrates a prior art inkjet printing system 2, wherein a curable hot-melt ink may be applied on a recording medium 20. The printing system 2 comprises a medium advance means 8 and a recording means 5.

In the illustrated prior art embodiment, the recording medium 20, e.g. paper or any other suitable medium for image-wise receiving ink drops from the inkjet printer 2, is moveable by means of the medium advance means 8. In the illustrated embodiment, the medium advance means comprises a platen 7. The medium advance means 8 are configured to move the medium 20 with respect to the recording means 5 in a direction A, which is hereinafter referred to as medium advance direction A.

The recording means 5 comprises four print heads 12a-12d, each comprising a set of nozzles 16. The print heads 12a-12d are configured to eject ink drops from the nozzles 16 such that the ink drops impinge on the medium 20 at a substantially predetermined position. The four print heads 12a-12d may each be configured to eject ink of a same color, e.g. black ink to generate a black image on the recording medium 20, or the print heads 12a-12d may each eject ink of a different color, e.g. cyan, magenta, yellow and black (CMYK), for generating a full color image on the recording medium 20.

The four print heads 12a-12d are arranged on a carriage 11 which is moveably supported on a guide rail 13. Thus, the carriage 11 is moveable in a scanning direction B. Hence, the four print heads 12a-12d are moveable with respect to the recording medium 20 in said scanning direction B. By suitably controlling the movement of the carriage 11 and the movement of the medium 20 in the medium advance direction A, while suitably controlling the ejection of ink drops from the nozzles 16 of the print heads 12a-12d, the printer 2 is enabled to generate an image on the recording medium 20. Such a printing method is well known in the art and is therefore not further elucidated herein.

The printing system 2 may apply hot-melt curable ink on the recording medium 20. For example, the ink may be heated in the print heads 12a-12d for providing fluid ink suitable for being ejected. Then the ink having an elevated temperature is ejected and is thus applied on the recording medium 20. On the recording medium 20, the ink cools down and the ink thereby thickens. Selecting a suitable ink that thickens at a predetermined rate allows to control the spreading on the recording medium 20 and the ink bleed between adjacent ink droplets. Then, after application on the recording medium 20, the ink is cured by suitable means (not shown in FIG. 1) by application of suitable curing energy.

It is noted that the method according to the present invention is not limited to use in an embodiment of a printer according to the exemplary, schematically illustrated printer of FIG. 1, but may as well be employed in any other suitably configured printing system 2.

FIG. 2 illustrates a method according to the present invention, in which a curable hot-melt ink is applied on a recording medium. In a first stage of the method, the ink is provided from an ink supply unit 10 in a fluid state to an inkjet print head 12. The inkjet print head 12 comprises an actuator chamber 14 and a nozzle 16 through which an ink droplet 18a may be ejected and applied on a medium such as a recording medium 20. In the first stage, in order to provide the curable hot-melt ink to the inkjet print head 12 the ink supply unit 10 may—in an embodiment—heat the curable hot-melt ink to an elevated temperature, such that the ink has a low ink viscosity (e.g. less than 50 mPa.s). In an alternative embodiment the ink comprises a gelling agent and the ink supply unit 10 may mechanically treat the curable hot-melt ink in order to break down the gel structure of the ink. The ink may be mechanically treated by stirring, shaking, agitating or the like. As a result of the mechanical treatment of the ink the curable hot-melt ink is provided with a low ink viscosity.

When the ink is in a fluid state, it may flow from the ink supply unit 10 to the print head 12. The print head 12 is configured such that in the actuator chamber 14 an amount of ink may be forced through the nozzle 16, e.g. by application of a pressure using an electromechanical transducer (e.g. a piezo element) or by any other suitable means. Thereby the ink droplet 18a is ejected from the nozzle 16 towards the receiving medium 20.

In a second stage of the method according to the present invention, an ejected ink droplet 18b is applied on the receiving medium 20 and upon application on the surface of the receiving medium 20, cools down. Due to the decrease in temperature, the ejected ink droplet 18b thickens. The thickening may be due to solidification or due to gelling or any other suitable thickening process. In any case, as a result of the cooling of the ejected ink droplet 18b the spreading of the droplet 18b on the surface of the receiving medium 20 is controlled. While cooling and thickening, the ejected ink droplet 18b moves relative to and away from the print head 12.

It is noted that, in an embodiment as illustrated in FIG. 1, the receiving medium 20 is movable relative to the print head 12 and the heat supply unit 22. In an alternative embodiment the heat supply unit 22 may be movably arranged such that it may move relative to the receiving medium 20. For example, in a known flatbed printer, the receiving medium 20 is provided on a stationary table of the printer. The printer comprises a moveably arranged gantry which supports a carriage. The carriage, which is moveably arranged on the gantry, is positioned relative to the receiving medium 20 by movement of the gantry and its own motion.

In a third stage of the method according to the present invention, the ejected ink droplet 18b is advanced into a heating area 23. The heating area 23 is provided by a heat supply unit 22 generating a suitable form of energy for heating a thickened droplet 18c. Such energy may be provided by a heated platen on which the receiving medium 20 is arranged or by contact free heating by application of infrared radiation, a heated air flow, microwaves or any other suitable form of energy.

In the heating area 23 the thickened ink droplet 18c is at least partly heated by the heat supply unit 22, thereby at least partly obtaining a decreased viscosity.

In the illustrated embodiment, contact free heating is applied; in particular infrared radiation is provided. The intensity of the infrared radiation and the duration of irradiation may be controllable by a control unit 30. The radiation may be focused by focusing means, such as a radiation reflector (not shown). Any other suitable means e.g. for controlling the heating or for increasing a heating efficiency may be employed for obtaining a desired level of heating.

For obtaining a desired gloss level, the heating may be configured to only heat a outer layer of the thickened droplet 18c. Thus, an inner layer, i.e. a part of the thickened ink droplet 18c in contact with the surface of the receiving medium 20, is not heated. Consequently, the inner layer remains thickened and ink spreading and ink bleed are prevented, while it has been found that the decrease in viscosity of the outer layer may result in an increased gloss level.

In a fourth stage of the method according to the present invention, the at least partly heated ink droplet 18d is provided in a curing area 33. A curing unit 32 is arranged such that curing energy may be provided to the at least partly heated droplet 18d.

In the curing area 33 the at least partly heated ink drop 18d is cured. In order to cure the at least partly heated ink drop 18d ultraviolet curing radiation or any other suitable radiation may be applied. As a result of the curing step the ink droplet is hardened and fixated on the receiving medium 20.

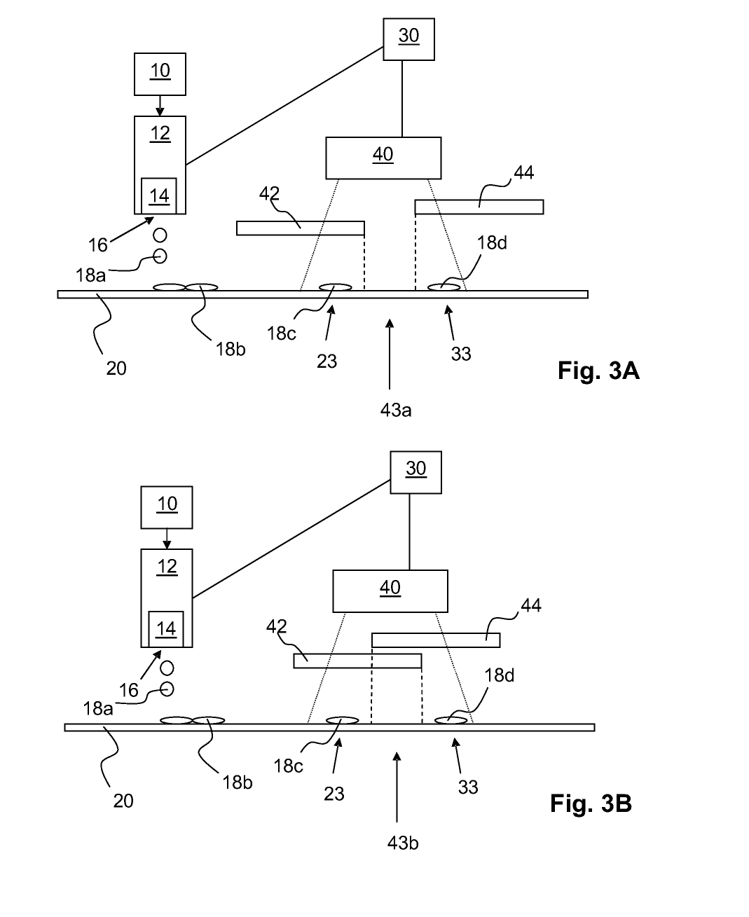

In the exemplary embodiment illustrated in FIG. 2, the control unit 30 is coupled to and is configured to control the operation of the print head 12, the heat supply unit 22 and the curing unit 32. So, the control unit 30 may control (I) the droplet ejection timing of the print head 12, (II) a heating timing, heating duration and/or a heating energy flux of the heat supply unit 22, possibly in synchronization with the droplet ejection timing and/or (III) a curing timing, curing duration and/or a curing radiation flux of the curing unit 32, possibly in synchronization with the droplet ejection timing and/or the heating timing. In a particular embodiment, the control unit 30 may be coupled to a user-interface (not shown) of the printing device. The user-interface may provide a user-setting enabling a user to set a desired gloss level. A corresponding user-settable parameter may thus be input by a user. In response to the user-settable parameter, the control unit 30 may control the operation of the print head 12, the heat supply unit 22 and/or the curing unit 32 in order to control the resulting gloss of the ink applied on the surface of the medium 20. Such control of the gloss level may be further increased by using the second embodiment as illustrated in and described in relation to FIGS. 3A and 3B.

FIGS. 3A and 3B illustrate the second embodiment of a method according to the present invention. The first and the second stage as described above are maintained the same. So, an ejected droplet 18b is moved towards the heating area 23. In the second embodiment, the heat supply unit is formed by an UV and infrared-radiation source 40 in combination with a UV-filter element 42. The curing unit is formed by the UV and infrared-radiation source 40 in combination with an infrared filter element 44. As illustrated in FIG. 3A, a heating and curing area 43a may be provided between the heating area 23 and the curing area 33.

In the illustrated second embodiment the heating of the thickened ink droplet 18c is carried out by infrared radiation and the curing of the at least partly heated ink droplet 18d is carried out by ultraviolet radiation and both radiations are provided by the single radiation source 40. Said radiation source may be an ultraviolet lamp, for example, in particular a Xenon XTC lamp. The radiation source 40 in operation generates and emits infrared radiation and ultraviolet radiation at the same time. The UV filter element 42 and/or the infrared filter element 44 are arranged in between the radiation source 40 and the ink droplets 18c, 18d, respectively, on the surface of the receiving medium 20. The UV filter element 42 blocks ultraviolet radiation and transmits infrared radiation, thereby providing heating energy in the heating area 23. As a result the thickened ink droplet 18c receives first only the infrared radiation and no ultraviolet radiation. Then, in the overlapping area 43a, if present, the at least partly heated droplet 18d receives infrared radiation and UV radiation, since the radiation generated by the radiation source 40 is not filtered. So, in the overlapping area 43a, the at least partly heated droplet 18d is heated and cured at the same time.

The infrared filter element 44 blocks infrared radiation and transmits ultraviolet radiation. As a result the at least partly heated ink droplet 18d receives only ultraviolet radiation and no infrared radiation in the curing area 33.

While the UV and infrared filter elements 42, 44 may be arranged stationary, they may—in an embodiment—be moveably arranged. By moving the filter elements 42, 44 relative to the radiation source 40 and/or the receiving medium 20, the duration of the presence of the ink droplets 18c, 18d in the heating area 23 and the curing area 33, respectively, may be controlled. Similarly, an amount of heating energy and curing energy supplied to the droplets 18c, 18d, respectively, may also be controlled.

In FIG. 3B the filter elements 42, 44 have been moved such that a no radiation area 43b is provided between the heating area 23 and the curing area 33. Hence, a total amount of heating energy and a total amount of curing energy is decreased compared to the configuration illustrated in FIG. 3A. Of course, with moving the filter elements 42, 44 independently, it is enabled to select virtually any size of the heating area 23, the curing area 33 and an intermediate area (i.e. the overlapping area 43a or the no radiation area 43b), if present.

In the second embodiment, the control unit 30 may be further coupled to actuating means (not shown) for moving the filter elements 42, 44 relative to the radiation source 40 and/or the receiving medium 20. Thus, the control unit 30 may be configured to more accurately control the gloss level of the resulting printed image by moving the filter elements 42, 44 and thereby controlling the duration of heating and curing and/or controlling the total amount of heating energy and curing energy provided to the ink.

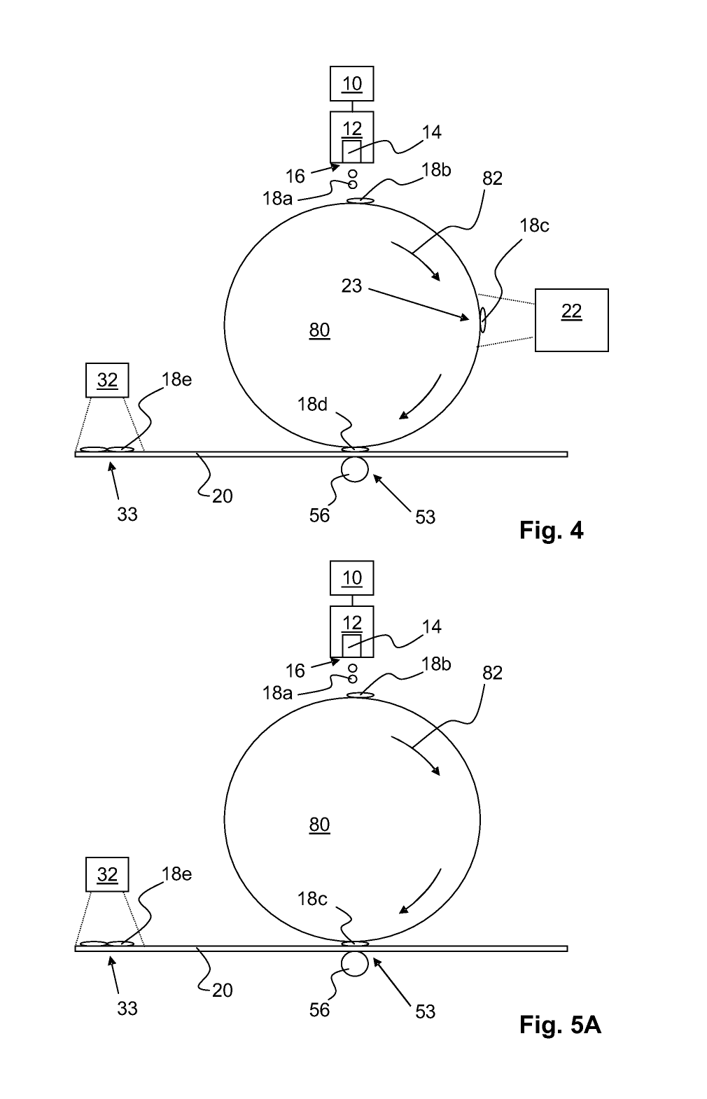

FIG. 4 shows a schematically view of an intermediate transfer process based on a method according to the present invention. An ink supply unit 10 provides ink in a liquid state to an inkjet print head 12. The inkjet print head 12 comprises an actuator chamber 14 and a nozzle 16. In the actuator chamber 14 an amount of ink is actuated and thereby a droplet of ejected ink 18a is ejected from the nozzle 16. The ejected droplet of ink 18a is applied onto an intermediate receiving member 80. The ejected ink droplet 18a, upon application on the surface of the intermediate receiving member 80 (hereinafter also referred to as intermediate 80), cools down, thereby becoming a thickened droplet 18b. As a result of the thickening of the ink droplet 18b the spreading of the droplet 18b on the surface of the intermediate receiving member 80 is controlled. The thickened droplet 18b is transported in a direction indicated by arrow 82 on the surface of the intermediate 80 towards a heating area 23. A heat supply unit 22 is arranged such that heating energy is supplied in the heating area 23. The heat supply unit 22 may be an infrared radiation source, for example.

In the heating area 23 the thickened ink droplet 18b on the surface of the intermediate receiving member 80 is at least partly heated by the heat supply unit 22, thereby becoming an at least partly heated ink droplet 18d.

In an alternative embodiment, the heat supply unit 22 may be arranged such that heating energy is applied on an inner surface of the receiving medium 80. In that case the heating energy may be supplied to the thickened ink droplet 18b via the material forming the intermediate receiving member 80.

After heating (or, in an embodiment, while heating) the at least partly heated ink droplet 18d transferred in the direction indicated by the arrow 82 to a transfer area 53. The transfer area 53 may be a transfer nip between a back roller 56 and the intermediate receiving member 80. In the transfer area 53 the at least partly heated ink droplet 18d is transferred to a recording medium 100, thereby becoming a transferred droplet 18e. It is noted that any other suitable means (other than a nip having a back roller) for bringing the at least partly heated ink droplet 18d into contact with the recording medium 100 may be suitably employed.

The transferred ink droplet 18e is advanced to a curing area 33. A curing unit 32 is arranged such that curing energy may be supplied to the transferred ink droplet 18e in the curing area 33. In the curing area 33 the transferred ink droplet 18e is cured. In the third embodiment shown in FIG. 4, a control unit as described in relation to FIGS. 2 and 3A-3B may be employed for controlling any parameters of the method, e.g. for optimizing a transfer efficiency and/or for controlling a gloss level of the resulting printed image.

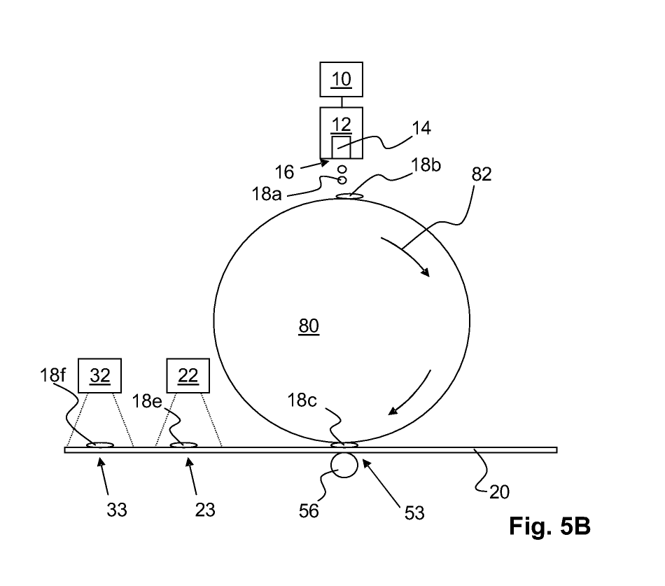

FIG. 5A shows a schematically view of a further embodiment of an intermediate transfer process in accordance with the present invention. In this embodiment the heating is performed during transfer in the transfer area 53. In the transfer area 53 the thickened ink droplet 18c is at least partly heated by a heated back roller 56. The heated back roller 56 provides pressure and heating energy to the receiving medium 20 and the thickened droplet 18c. As a result of the use of the heated back roller 56 the thickened ink droplet 18c is at least partly heated during transfer, e.g. for improving a transfer efficiency and/or for improving adhesion of the transferred ink droplet 18e. Of course, the heating may as well be provided by any other suitable means. For example, heating the intermediate 80 at an inner surface, as above described, may be a suitable means. FIG. 5B shows a schematically view of a further embodiment of an intermediate transfer process in accordance with the present invention. In this embodiment, which is shown as similar to the embodiment of FIG. 5A, a heating area 23 is provided such that the transferred droplet 18e is at least partly heated again by a heat supply unit 22. Then, the at least partly heated transferred droplet 18f is transferred to the curing area 33 for curing. In this embodiment, a first heating step is provided for controlling the transfer from the intermediate 80 to the recording medium 20 and a second heating step is provided for controlling a gloss level of the resulting printed image.

It is noted that such a second heating step could as well be added to the embodiment as shown in and described in relation to FIG. 4. In particular, when combined with the embodiment of FIG. 4, the first heating e.g. using infrared radiation may be configured to only heat an outer layer of the thickened ink droplet 18b arranged on the intermediate 80 for improving transfer without influencing droplet spreading and bleed and the second heating e.g. also using infrared radiation may be configured to only heat an outer layer of the transferred droplet 18e arranged on the recording medium 20 for controlling gloss also without influencing droplet spreading and bleed.

Further, it is noted that in the embodiments using an intermediate 80, an image may be formed on the intermediate 80 in a number of rotations of the intermediate 80. So, the heat supply unit 22 (FIGS. 4 and 5B), the heated back roller 56 (FIG. 5A-5B) and the curing unit 32 may be switched off while the image is being formed by multiple rotations (multi-pass print strategy as well known in the art) and no transfer is performed. Then, when the image has been formed, it may be transferred to the recording medium 20 by switching on the heat supply unit 22 (FIGS. 4 and 5B), the heated back roller 56 (FIG. 5A-5B) and the curing unit 32. Thus, an energy efficient embodiment is obtained, while improving image quality. The image quality is improved since all applied and thickened droplets 18b are similarly heated on the intermediate 80 prior to or during transfer, thereby preventing differences between thickened droplets 18b applied during a first rotation and thickened droplets 18b applied during a subsequent (later) rotation.

Detailed embodiments of the present invention are disclosed herein; however, it is to be understood that the disclosed embodiments are merely exemplary of the present invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. Method for applying a curable hot-melt ink on a medium comprising the steps of:
(a) providing an amount of curable hot-melt ink in a fluid state;
(b) applying at least a part of the fluid ink at an elevated temperature on a surface of the medium, the ink cooling upon the application on the surface;
(c) reheating at least a part of the ink applied on the surface of the medium such that a reheated fraction of the ink returns to a fluid state; and
(d) curing at least the reheated fraction of the ink that has returned to the fluid state;
wherein step c) is started before step d) is started.

2. Method according to claim 1, wherein the medium is a recording medium and, in step d), the ink is on the surface of the recording medium.

3. Method according to claim 1, wherein the medium is an intermediate transfer member and the method further comprises the step of transferring the ink from said surface of the intermediate transfer member to a surface of a recording medium before curing the ink.

4. Method according to claim 1, wherein the curable hot-melt ink comprises at least one gelling agent and wherein in step b) the gelling agent forms a gel state in said ink upon cooling.

5. Method according to claim 1, wherein step c) comprises providing infrared radiation to at least a part of the ink applied on the surface.

6. Method according to claim 1, wherein the curable hot-melt ink is curable by UV radiation and wherein step d) comprises providing UV radiation to the ink applied on the surface.

7. Method according to claim 1, wherein step c) comprises providing infrared radiation to only a part of the ink applied on the surface, said part of the ink not being in contact with the surface of the medium.

8. Method according to claim 1, wherein step d) is started while step c) is being carried out.

9. Method according to claim 1, wherein step c) is ended before step d) is started.

10. Method according to claim 1, wherein in step c), the at least a part of the ink applied on the surface of the medium is an outer layer of a droplet applied on the surface of the medium.

11. Printing device for applying a curable hot-melt ink on a medium, the printing device comprising:
(a) an ink supply means configured for providing at least an amount of the ink in a fluid state;
(b) an ink application means in fluid coupling with the ink supply means for receiving the fluid ink, the ink application means being configured for applying the fluid ink to a surface of the medium at an elevated temperature;
(c) a heating means configured for heating at least a part of the ink applied on the surface of the medium;
(d) a curing means configured for curing the ink.

12. Printing device according to claim 11, wherein said heating means is an infrared radiation generating means, which infrared radiation generating means is arranged to provide infrared radiation to the part of the ink applied on the surface of the medium.

13. Printing device according to claim 11, wherein said curing means is a UV radiation generating means, which UV radiation generating means is configured to provide UV radiation to ink applied on a surface of a recording medium.

14. Printing device according to claim 11, wherein the infrared radiation generating means and the UV radiation generating means are provided by a single radiation means, the printing device further comprising a filter element configured for filtering UV radiation and transmitting infra red radiation, and wherein the radiation means and the filter element are arranged relative to each other such that in operation ink applied on a surface is first irradiated by the infrared radiation only and thereafter is irradiated by UV radiation.

15. Printing device according to claim 11, wherein the medium is an intermediate transfer member, wherein the intermediate transfer member is arranged to transfer the ink onto a recording medium.

16. Printing device according to claim 11, wherein a gloss level of a resulting image is a user-settable parameter, the printing device further comprising a control unit configured to control the heating means in response to the user-settable parameter for controlling the heating of the part of the ink applied on the surface of the medium corresponding to the user-settable parameter.
